(19) United States
(12) Patent Application Publication
(10) Pub. No.: US 2007/0117001 A1
(43) Pub. Date: May 24, 2007

(54) Method of fabricating flow field plates and related products and methods

(76) Inventors: Simon Farrington, Vancouver (CA); Steven D. Gabrys, Vancouver (CA); William D. Gray, Richmond (CA); Wendy J. Lee, West Vancouver (CA); John Cameron Marshall, Surrey (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/283,491

(22) Filed: Nov. 18, 2005

(51) Int. Cl. H01M 8/02; B05D 5/12

(52) U.S. Cl. 429/38; 427/115

(57) ABSTRACT

An improved flow field plate and methods related to the manufacture of the same. Flow field plates are at least partially coated with a low viscosity coating resin to increase mechanical strength and/or to decrease fluid permeability, and find particular utility for manufacturing thin, carbonaceous flow field plates for fuel cell stacks.

### BACKGROUND OF THE INVENTION

1. Field of the Invention

The present invention relates to methods of making improved flow field plates for fuel cells, as well as to flow field plates having selectively strengthened regions.

2. Description of the Related Art

Electrochemical fuel cells convert fuel and oxidant into electricity. Solid polymer electrochemical fuel cells generally employ a membrane electrode assembly which includes an ion exchange membrane or solid polymer electrolyte disposed between two electrodes typically comprising a layer of porous, electrically conductive sheet material, such as carbon fiber paper or carbon cloth. The membrane electrode assembly comprises a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

The membrane electrode assembly is typically interposed between two electrically conductive flow field plates, or separator plates, to form a fuel cell. Such flow field plates comprise flow fields to direct the flow of the fuel and oxidant reactant fluids to the anode and cathode electrodes of the membrane electrode assemblies, respectively, and to remove excess reactant fluids and reaction products, such as water formed during fuel cell operation.

Flow field plates may comprise two plates, namely the anode flow field plate and the cathode flow field plate, which can be combined to form a bipolar flow field plate. The anode flow field plate and the cathode flow field plate may each comprise two surfaces: an active surface that faces and contacts the reactant fluids and the corresponding electrodes, and a non-active surface that faces a non-active surface of the adjoining plate. The active sides of the plates may comprise of landings that form flow field channels and contact the electrodes of the MEA when assembled into a fuel cell. In some cases, the anode flow field plate and the cathode flow field plate can be attached to each other by an adhesive, chemical bond, or mechanical bond to form a single flow field plate such that the non-active surface of each plate faces each other. In this configuration, the bipolar flow field plate comprises two active surfaces, a first active surface that comprises fuel flow fields and a second active surface that comprises oxidant flow fields. In addition, the non-active surface of the two plates may comprise coolant flow fields to allow the flow of coolant through the bipolar flow field plate. Alternatively, the non-active surface of only one of the two plates may comprise coolant flow fields.

Flow field plates serve many functions in a fuel cell. They act as current collectors, provide support for the electrodes, and provide passages for the reactants and products. Furthermore, flow field plates act as dividers to separate the reactant fluid streams and coolant streams and prevent them from mixing with one another. Thus, flow field plates need to be substantially fluid impermeable (that is, impervious to typical fuel cell reactants and coolants to substantially isolate each of the fuel, oxidant, and coolant streams).

Expanded graphite, also known as flexible graphite, is one material that is used for flow field plates. Because expanded graphite is compressible, embossing or compression molding processes may be employed to form planar flow field plates. The embossing step serves two purposes. First, it forms the desired shape of the flow field plate wherein flow fields may be formed on the surfaces of the flow field plate. Second, it densifies the porous expanded graphite sheet so that the resulting flow field plate is substantially fluid impermeable. Various embossing methods such as roller embossing and reciprocal (or stamp) embossing may be used. Embossing pressures are typically high in order to maximize densification of the flow field plate to prevent fluids from permeating through the thickness of the flow field plate, for example, between 500 and 2000 PSI.

Void space may still remain in the flow field plate after embossing. Thus, embossed graphite flow field plates are typically impregnated with resin to ensure that all the remaining void space in the flow field plate, which was not removed during the embossing step, is substantially filled with resin, as well as to improve the mechanical strength and stiffness of the flow field plate. These resins may be any curable polymeric material, such as methacrylate, or any thermoset or thermoplastic resin commonly used for fuel cell flow field plates, such as phenols, epoxies, melamines, and/or furans.

Such polymeric impregnating resins, however, are electrically and thermally insulating. Thus, when the flow field plates are assembled to form a fuel cell wherein one surface of the flow field plate is in contact with the membrane electrode assembly, the resin will create an area of high contact resistance at the contacting points of the flow field plate and the electrode, thereby decreasing performance of the fuel cell. As a result, resin-impregnated flow field plates are typically subjected to a wash stage to remove the surface resin from the first two to twenty microns of the flow field plate surface, thus creating a slightly porous surface.

Removal of surface resin limits the minimum achievable thickness of flow field plates by decreasing mechanical strength and/or increasing fluid permeability. Therefore, the thickness of flow field plates cannot be significantly decreased without adversely affecting desired properties. However, in order to maximize power density of the fuel cell stack, it is desirable for fuel cell stack components to be as thin as possible.

Given these problems, there remains a need to improve flow field plate functionality and durability. The present invention addresses these issues and provides further related advantages.

### BRIEF SUMMARY OF THE INVENTION

In one embodiment, a bipolar flow field plate is disclosed, the bipolar flow field plate comprising a first and a second electrically conductive flow field plate, wherein each flow field plate comprises a first surface and an opposing second surface. The flow field plates further comprise at least one reactant flow field on the first surface, for example, fuel or oxidant flow fields. At least one of the opposing second surfaces of the first and second flow field plates may comprise coolant flow fields. The flow field plates are joined together such that the second surface of each flow field plate faces each other to form a bipolar flow field plate. The flow field plates may further comprise manifold openings for supply and exhaust of reactant fluids and coolant.

In another embodiment, a method of fabricating such flow field plates is disclosed, the method comprising the steps of embossing a first flow field on a first surface of a sheet of electrically conductive material; impregnating the sheet with a polymeric impregnating resin; removing a portion of the resin from at least one of the first surface and an opposing second surface of the sheet to form at least one resin-depleted surface; applying a coating of low viscosity coating resin to at least a portion of the at least one resin-depleted surface; and curing the low viscosity coating resin; and further comprising the step of curing the polymeric impregnating resin prior to or after the step of applying the coating of low viscosity coating resin.

In one alternative, the low viscosity coating resin is coated on areas that experience high mechanical loads, for example, the transition regions of the flow field plates that comprise the largest span of unsupported material and the seal grooves, wherein the low viscosity coating resin penetrates into the resin-depleted surface without significantly increasing the thickness of the plate. In another alternative, the second surface of the flow field plate is substantially coated with the low viscosity coating resin such that the low viscosity coating resin penetrates into the resin-depleted surface without significantly increasing the thickness of the plate. In both alternatives, the low viscosity coating resin improves the mechanical properties of the flow field plates, for example increasing the stiffness of the flow field plates, and does not substantially increase the thickness of the flow field plate.

In a further embodiment, the method further comprises a step of joining the first and second flow field plates to form a bipolar flow field plate, wherein the first surface of the first flow field plate comprises fuel flow fields, the first surface of the second flow field plate comprises oxidant flow fields, and at least one of the second surfaces of the first and second flow field plates comprises coolant flow fields. A bipolar flow field plate is formed by assembling the two flow field plates together such that the opposing second surfaces of each flow field plate face each other. The bipolar flow field plate is then cured for a predetermined length of time at a predetermined temperature, both of which are dependent on the resin type. In one alternative, the low viscosity coating resin acts as an adhesive to adhesively join the first flow field plate to the second flow field plate.

In still another embodiment, the low viscosity coating resin is applied to the second surfaces of the first and second flow field plates after adhesively joining the first and second flow field plate to form a bipolar flow field plate, wherein the second surface of the first flow field plate faces the second surface of the second flow field plate. The low viscosity coating resin may be applied by filling or pumping the low viscosity coating resin, via an external pumping device, through the coolant flow fields formed on the second surface of at least one of the first and second flow field plates, and then draining the excess. In this manner, the low viscosity coating resin penetrates into the resin-depleted surface so that it does not substantially increase the thickness of the flow field plate. The plates are then cured for a predetermined length of time at a predetermined temperature, both of which are dependent on the resin type.

These and other aspects of this invention will be evident upon reference to the attached figures and following detailed description.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1a shows a planar view of a first surface of an anode flow field plate with fuel flow fields thereon.

FIG. 1b shows a planar view of a second surface of an anode flow field plate with coolant flow fields thereon.

FIG. 2a shows a planar view of a first surface of a cathode flow field plate with oxidant flow fields thereon.

FIG. 2b shows a planar view of a second surface of a cathode flow field plate with coolant flow fields thereon.

FIG. 2c shows an enlarged view of FIG. 2B.

FIG. 3 shows a cross-sectional view of a transition region of a bipolar flow field plate.

FIG. 4 shows a cross-sectional view of a transition region of a bipolar flow field plate under a stack compression pressure.

FIG. 5 shows a flow chart of methods of making a bipolar flow field plate.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

The present improved flow field plate for a fuel cell with improved mechanical properties comprises a compressible, electrically conductive material impregnated with a polymeric impregnating resin, wherein at least a portion of the flow field plate is at least partially surface impregnated with a low viscosity coating resin, and a method of fabricating the same. Suitable materials for the flow field plate include carbonaceous and graphitic materials, such as expanded or flexible graphite.

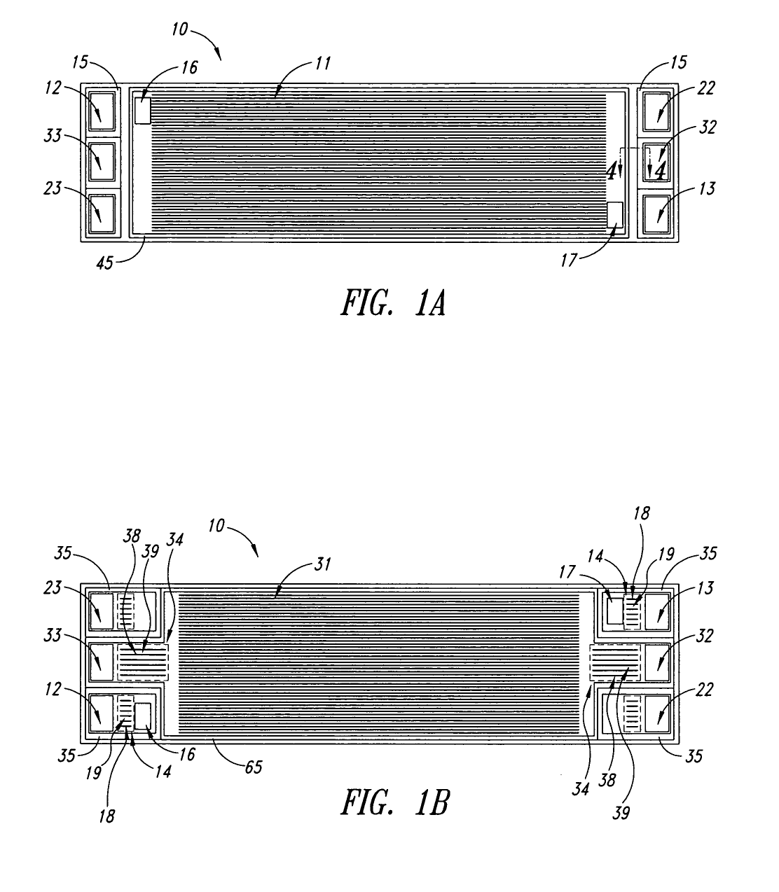

FIG. 1a shows a representative anode flow field plate 10 comprising fuel flow fields 11 to allow flow of fuel from fuel inlet manifold opening 12 to fuel outlet manifold opening 13. Anode flow field plate 10 further comprises fuel transition regions 14 (shown in the dotted boxes in FIG. 1b) for allowing fuel flow fields 11 to be fluidly connected to fuel inlet manifold opening 12 through fuel backfeed inlet slot 16 and fluidly connected to fuel outlet manifold opening 13 through fuel backfeed outlet slot 17. Fuel transition regions 14 comprise a plurality of ridges 18 that form fuel transition flow passages 19 (shown in FIG. 1b) to allow the passage of fuel between fuel inlet manifold opening 12 and fuel backfeed inlet slot 16 and between fuel outlet manifold opening 13 and fuel backfeed outlet slot 17. Although anode flow field plate 10 further comprises oxidant inlet manifold opening 22, oxidant outlet manifold opening 23, coolant inlet manifold opening 32, and coolant outlet manifold opening 33, manifold seal groove 15 provides a space for a manifold seal (not shown) which prevents the fuel from passing into the aforementioned manifold openings. Anode flow field plate 10 further comprises seal groove 45 that provides a space for a seal (not shown) for retaining fuel within fuel flow fields 11 and associated areas.

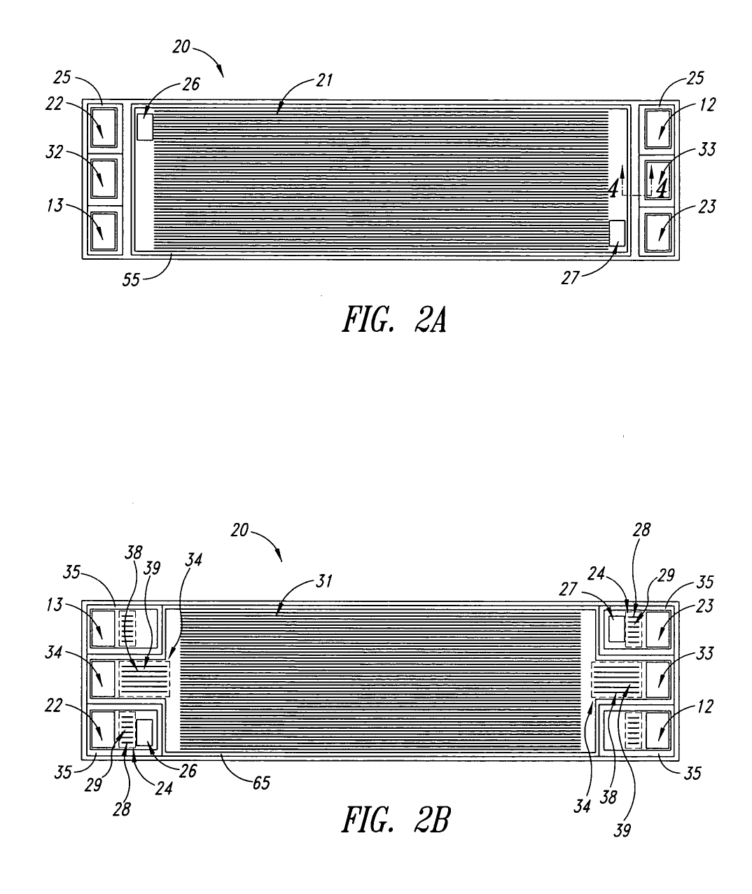

Similarly, FIG. 2a shows a representative cathode flow field plate 20 comprising oxidant flow fields 21 to allow flow of oxidant (e.g., air) from oxidant inlet manifold opening 22 to oxidant outlet manifold opening 23. Cathode flow field plate 20 further comprises cathode transition regions 24 (shown in the dotted boxes in FIG. 2b) for allowing oxidant flow fields 21 to be fluidly connected to oxidant inlet manifold opening 22 through oxidant backfeed inlet slot 26 and fluidly connected to oxidant outlet manifold opening 23 through oxidant backfeed outlet slot 27. Again, the oxidant transition region comprises a plurality of ridges 28 that form oxidant transition flow passages 29 (shown in FIG. 2b) to allow the passage of air between oxidant inlet manifold opening 22 and oxidant backfeed inlet slot 26 and between oxidant outlet manifold opening 23 and oxidant backfeed outlet slot 27. Cathode flow field plate 20 further comprises fuel inlet manifold opening 12, fuel outlet manifold opening 13, coolant inlet manifold opening 32, and coolant outlet manifold opening 33, and further comprises manifold seal groove 25 that provides a space for a manifold seal (not shown), which prevents air from passing into the aforementioned manifold openings. Cathode flow field plate 20 further comprises seal groove 55 that provides a space for a seal (not shown) for retaining oxidant within oxidant flow fields 21 and associated areas.

Coolant flow fields may be formed on either or both of the second surface of anode flow field plate 10 and/or cathode flow field plate 20. FIGS. 1b and 2b show one example where coolant flow fields 31 are formed on the second surface of anode flow field plate 10 and cathode flow field plate 20. Coolant transition regions 34 (shown in the dotted boxes of FIGS. 2a and 2b) comprise a plurality of ridges 38 that form coolant transition flow passages 39 to allow coolant flow fields 31 to be fluidly connected to coolant inlet manifold opening 32 and coolant outlet manifold opening 33. The second surfaces of anode flow field plate 10 and cathode flow field plate 20 further comprise fuel inlet manifold opening 12, fuel outlet manifold opening 13, oxidant inlet manifold opening 22 and oxidant outlet manifold opening 23, and further comprises manifold seal groove 35 that provides space for a manifold seal (not shown), which prevents coolant from passing into the aforementioned manifold openings. Both second surfaces of the anode and cathode flow field plates 10 and 20 further comprise seal groove 65 that provides a space for a seal (not shown) for retaining coolant within coolant flow fields 31 and associated areas. While both second surfaces of the anode and cathode flow field plates 10 and 20 are shown with coolant flow fields in FIGS. 1b and 2b, in an alternative embodiment, the second surface of only one of the anode flow field plate or the cathode flow field plate comprises coolant flow fields.

As mentioned above, it is undesirable to have resin on the first and/or the second surfaces of the flow field plates because most polymeric impregnating resins are electrically- and/or thermally-insulating. This leads to loss of fuel cell performance due to contact resistance, as well as possible “hot spots” that may form in the fuel cell and the membrane electrode assembly (MEA) during operation because heat cannot be uniformly conducted or removed from the MEA. Furthermore, the polymeric impregnating resin may form non-uniform surface clusters that lead to thickness tolerance issues when assembled into a fuel cell stack and compressed under a fuel cell stack compression pressure. Thus, at least a portion of the polymeric impregnating resin at the surface of at least one of the first and second surfaces of the flow field plate is removed, preferably to a depth of 2 to 20 microns from either surface of the flow field plate.

Removal of the polymeric impregnating resin from the surface often leads to a decrease in mechanical strength and/or may increase fluid permeability, particularly for thin plates. Thus, at least a portion of at least one of the first and second surfaces of the flow field plate is at least partially coated and/or impregnated with a thin layer of low viscosity coating resin. A low viscosity coating resin is desirable in order to ensure that the resin saturates the surface pores, and also permits the use of a thin coating so as to not significantly increase the thickness of the flow field plate. The low viscosity coating resin preferably has a viscosity less than 400 cp, and more preferably less than 100 cp. Examples of suitable low viscosity coating resins include epoxy resins or an acrylic, vinyl ester, or cyanate ester, as well as other commercially available resins that are diluted to the desired viscosity.

The low viscosity coating resin is particularly advantageous for thin plates because, as the plate thickness decreases, mechanical strength decreases and/or permeability increases. However, by having a thin layer of low viscosity coating resin on at least one surface of the flow field plate, mechanical strength and/or fluid impermeability through the thickness of the plate are improved. In one embodiment, only those areas of the flow field plate bridging the largest unsupported spans, such as the seal grooves in the transition regions of the flow field plate, are coated with the low viscosity coating resin to impart increased mechanical strength in those areas. The transition regions 14, 24, and 34 of FIGS. 1a, 1b, 2a and 2b are typically the weakest portions of the flow field plate because they comprise the largest area of unsupported material that bridges various openings. In particular, the coolant transition region is one of the weakest areas of the flow field plate because it is typically the hottest area of the plate. In one embodiment, the first surface of the flow field plate that is in contact with the MEA (for example, the fuel and oxidant flow fields) is not coated with the low viscosity coating resin, as the low viscosity coating resin may decrease electrical and/or thermal conductivity of the plate if too much is applied, and may even introduce contaminants into the MEA in some cases.

A bipolar flow field plate may be formed by joining anode flow field plate 10 (FIG. 1a) and cathode flow field plate 20 (FIG. 2a) such that the second surfaces of each flow field plate (i.e., FIGS. 1b and 2b) face each other. In one alternative, anode flow field plate 10 and cathode flow field plate 20 are adhesively joined together around a peripheral edge thereof to ensure that the coolant flowing therebetween does not leak out of the bipolar flow field plate. In one embodiment, the adhesive material is the same material as the low viscosity coating resin.

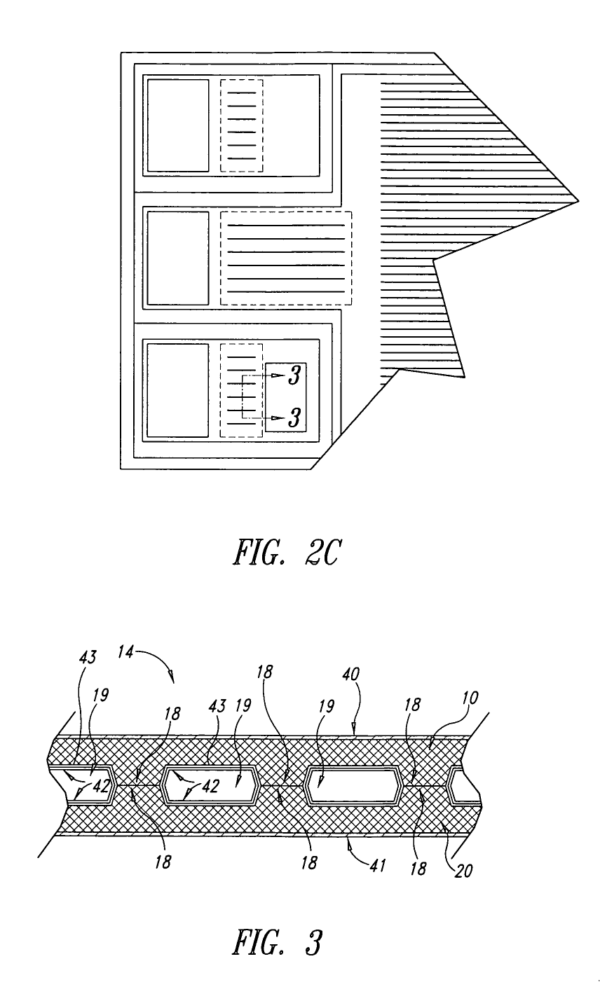

FIG. 2c shows an enlarged portion of FIG. 1b, while FIG. 3 shows a cross-section through section 3-3 of FIG. 2c. In this regard, it should be understood that FIG. 3 depicts a cross section of the bipolar flow field plate formed by joining anode flow field plate 10 and cathode flow field plate 20. Referring to FIG. 3, anode flow field plate 10 is placed on top of cathode flow field plate 20 such that the second surfaces (as shown in FIGS. 1b and 2b) face each other. Fuel transition flow passages 19 are formed upon contact at ridges 18. As shown in FIG. 3, the surfaces of fuel transition flow passages 19 are reinforced with a coating of low viscosity coating resin 42 (e.g., an epoxy “skin”) that at least partially impregnates the pores of the second surfaces of anode flow field plate 10 and cathode flow field plate 20 that are resin-depleted (see areas 43). Ridges 18 may be similarly reinforced prior to joining anode flow field plate 10 with cathode flow field plate 20. Alternatively or in combination, and in a similar manner, the resin-depleted surfaces of any of cathode ridges 28, cathode transition flow passages 29, coolant ridges 38, and/or coolant transition flow passages 39 may be impregnated with a low viscosity resin to form an epoxy skin thereon to enhance mechanical strength. Furthermore, all or a portion of coolant flow fields 31 may be reinforced with such an epoxy skin 42 to further improve mechanical strength.

FIG. 3 further illustrates resin-depleted surfaces 40 and 41 on the first surface of anode flow field plate 10 and the first surface of cathode flow field plate 20, respectively, in order to minimize electrical contact resistance between the first surfaces of the flow field plates and the contacting MEAs (not shown) adjacent thereto when assembled into a fuel cell.

Under a fuel cell stack compression pressure, regions that comprise large spans of unsupported area, such as transition regions 14, 24 and 34, are typically subjected to high stresses. For example, a fuel cell stack is formed when a plurality of fuel cells are stacked together. Typically, fuel cell stacks are sealed around each manifold opening and around the circumference of the bipolar flow field plate and compressed under a compression pressure to ensure a substantially fluid leak tight fuel cell stack.

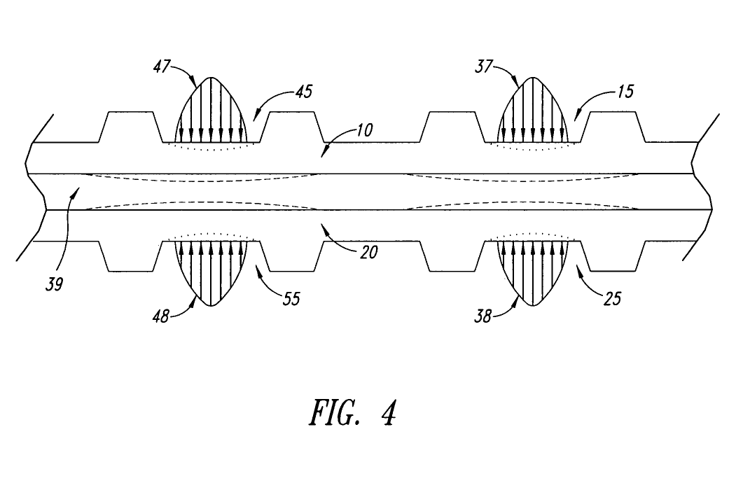

Under a stack compression pressure, the walls of coolant transition flow passages 39 of the bipolar flow field plate will deform to resist the normally applied seal load from seal 37 within manifold seal groove 15 and seal 47 within seal groove 45 of FIG. 1a, and seal 38 with manifold seal groove 25 and seal 48 within seal groove 55 of FIG. 2a. This is illustrated in FIG. 4 which shows a cross-section take along line 4-4 of FIGS. 1a and 2a. Because the distance between each coolant transition flow passages is large and unsupported, the walls of coolant transition flow passages 39 will deform under tension (as shown by displaced dashed lines). Similarly, the surfaces of seal grooves 15, 25, 45 and 55 will be compressively deformed due to the seal load from the stack compression pressure (as shown by the displaced dotted lines). The present invention allows such unsupported areas to be selectively strengthened, without substantially increasing the thickness of the components.

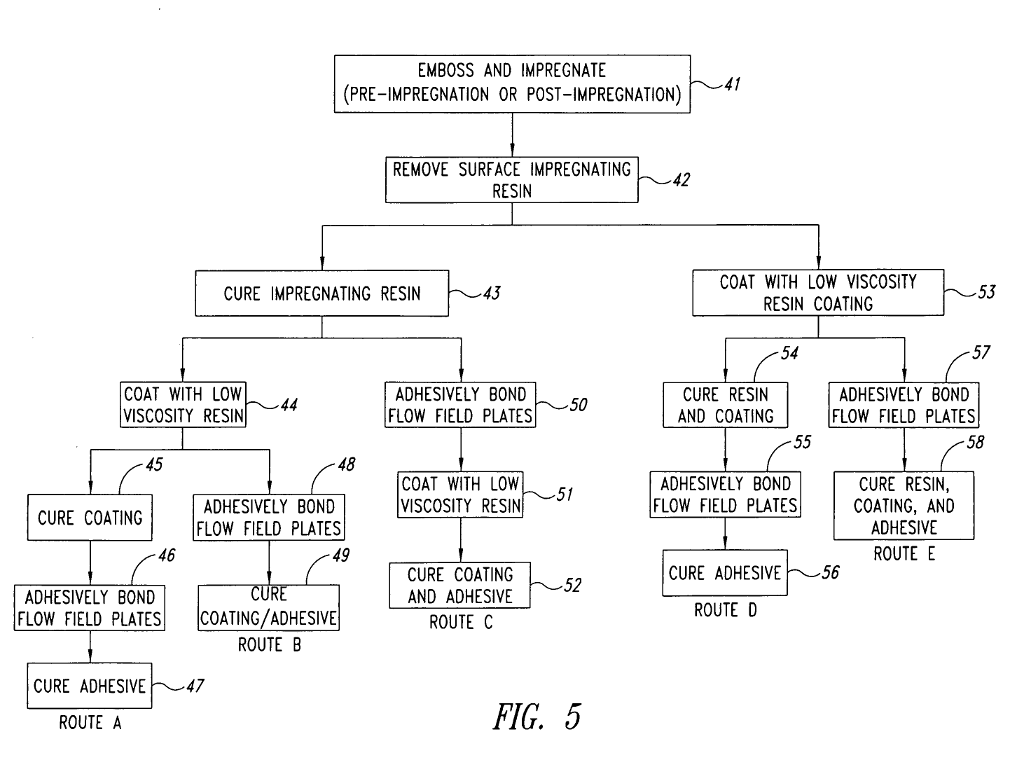

Referring to the flow chart in FIG. 5, the initial step (41) in this method is to emboss and/or compression mold and resin-impregnate a commercially-available electrically conductive sheet of material, for example, a porous expanded graphite sheet, to form a flow field plate. Embossing or compression molding substantially increases the density and mechanical strength of the sheet while removing the pores, or void space, therein to decrease fluid permeability through the thickness of the flow field plate. The sheet may be roller-embossed and/or reciprocal-embossed to form reactant flow fields, such as fuel and oxidant flow fields, on the first surface of the sheet. By embossing the sheet at a sufficiently high pressure, the sheet may be compressed to form a planar sheet with a thickness of, for example, less than 1 millimetre. The header region of the flow field plate typically comprises manifold openings, seal grooves, and/or transition regions that may also be formed by these embossing methods as a separate step or simultaneously. One of ordinary skill in the art will appreciate the various methods of embossing or compression molding, and such methods need not be further exemplified herein. Additionally, coolant flow fields may be embossed on the second surface of the sheet, either as a separate step or simultaneously with the first surface. This forms flow field plates with reactant flow fields on the first surface, and coolant flow fields on the second surface.

In most cases, the embossed flow field plates are still more porous and more flexible than desired, even when embossed to densities of 1.1 to 1.8 g/cm³. Thus, after or during embossing, the embossed flow field plates are impregnated with a polymeric impregnating resin, such as phenolic resins, epoxy resins, acrylic resins, melamine resins, polyamide resins, polyamideimide resins, and/or phenoxy resins, to impart strength into the embossed flow field plates. This can be achieved by any method of resin impregnation known to one of ordinary skill in the art, including, for example, spray coating, dip coating, and vacuum impregnation. To dip coat, the embossed flow field plates are submerged into a bath of polymeric resin for a period of time, thus allowing the embossed flow field plates to soak up the polymeric resin. Additionally, for vacuum impregnation, the embossed flow field plates and the resin are degassed separately in a chamber for a period of time. The embossed flow field plates are then immersed into the polymeric impregnating resin under a vacuum. The chamber enclosing the immersed embossed sheets may be pressurized to facilitate impregnation, particularly to force-impregnate pores that are otherwise difficult to penetrate. Optionally, the embossed flow field plates may be baked before resin impregnation to remove any trapped or adsorbed fluids from the pores. Furthermore, in one method, referred to as “resin pre-impregnation”, the sheet is impregnated with resin prior to embossing, and in another method, referred to as “resin post-impregnation”, the sheet is impregnated with resin after embossing.

The next step (42) of this method is to remove surface resin, usually by washing off excess resin from the surface of the resin-impregnated flow field plate via a washing process because, as mentioned before, it is undesirable to have resin at the surface of the flow field plates that contact the MEA because most polymeric impregnating resins are electrically- and/or thermally-insulating. This process may comprise the steps of washing and rinsing off the surface resin with a suitable liquid, such as a surfactant, solvent, or water. It is desirable to remove only two to twenty microns of the polymeric impregnating resin, and more preferably two to ten microns, from the surface of the impregnated flow field plate because if too much resin is removed, it will have a negative effect on the mechanical strength and permeability of the final flow field plate. Therefore, the washing process should be optimized to ensure that only the desired amount of resin is removed from the surface of the impregnated flow field plate.

After steps 41 and 42, there are several alternative methods to coat the first and/or second surface of the flow field plate with a low viscosity coating resin, curing the low viscosity resin, and forming a bipolar flow field plate, as illustrated by Routes A, B, C, D, and E in FIG. 5.

In Routes A, B, C, the embossed flow field plate is subjected to an elevated temperature and/or pressure to cure the polymeric impregnating resin (43), either in an oven or pressurized oven, or by submerging the plate in a water bath. Curing imparts strength to the plate. Curing times and temperature will depend on the type of resin that was used for impregnation. Typical curing times range from 15 minutes to 120 minutes and typical curing temperatures range from 80° C. to 150° C.

After curing, in Route A, at least one of the surfaces of the impregnated flow field plate is coated with a low viscosity coating resin (44). It is preferable that the low viscosity coating resin at least partially impregnates or saturates the pores at the resin-depleted surface and does not significantly introduce excess resin that significantly increases the thickness of the flow field plate, as this may lead to tolerance issues when the fuel cell stack is compressed under a stack compression pressure.

In order to ensure adequate penetration of the low viscosity coating resin into the resin-depleted surface, the viscosity of the low viscosity coating resin should have a viscosity of less than 400 cp, and typically less than 100 cp. In some cases, a commercially available resin may be diluted with a suitable solvent to decrease the resin viscosity to a desirable level. In one embodiment, the low viscosity coating resin is only coated on the second surface of the flow field plate, wherein the second surface comprises coolant flow fields thereon. As the second surface of the impregnated flow field plate does not contact the MEA, resin at the surface of the second surface will have an insignificant effect on fuel cell performance. Thus, it is desirable to have a thin coating of the low viscosity resin on only the second surfaces of the flow field plates to keep the flow field plates as thin as possible, while not introducing any adverse effects on fuel cell performance. In another embodiment, at least a portion of at least one of the first and second surfaces are coated with the low viscosity coating resin, preferably in the areas that are the thinnest and supports high mechanical loads, such as, but not limited to, in the header regions of the flow field plate and/or the seal grooves.

After coating the low viscosity coating resin, the next step of Route A is to cure the low viscosity coating resin (45). This may be performed in an oven at an elevated temperature, or may also be performed in a water bath at an elevated temperature. Curing times and temperature will depend on the type of low viscosity coating resin that was used for coating. The cured plates are then adhesively bonded (46) to form a bipolar flow field plate by adhesively bonding anode flow field plate 10 to cathode flow field plate 20 using an epoxy around the peripheral edge of the plates, and/or around each manifold openings such that the second surfaces of each of the flow field plates face each other. If necessary, the adhesive may then be cured in step (47).

In this embodiment, coolant channels and coolant transition regions may be formed from corresponding coolant flow fields on either or both of the second surfaces of the anode flow field plate and the cathode flow field plate. A layer of epoxy skin (from the coating of the low viscosity coating resin) is formed on the surface of coolant channels and coolant transition region, while resin-depleted surfaces are formed on the surface of fuel flow fields and oxidant flow fields. In one alternative, the seal grooves may also comprise a layer of epoxy skin on the surfaces thereof.

In Route B after step (43), the low viscosity coating resin is coated on the at least one surface of the impregnated flow field plate (44). Adhesive may then be applied (48). Alternatively, the low viscosity coating resin itself may serve as the adhesive to bond the anode flow field plate and the cathode flow field plate to form a bipolar flow field plate. This eliminates the need for application of additional adhesive. If necessary, the low viscosity coating resin may then be cured (49) to form the bipolar flow field plate.

In Route C of FIG. 5, the two flow field plates may be adhesively bonded together (50) after the step of curing the polymeric impregnating resin (43). The low viscosity coating resin may then be applied (51) by, for example, introducing the low viscosity coating resin into the coolant flow fields (e.g., by a pumping device) and then draining any excess resin, followed by optionally curing the low viscosity coating resin and the adhesive (52), thus forming the bipolar flow field plate.

In Route D in FIG. 5, after step (42), at least one of the surfaces of the impregnated flow field plate is coated with the low viscosity coating resin (i.e., prior to curing of the polymeric impregnating resin). The polymeric impregnating resin and the low viscosity coating resin may then be cured in a single step (54) by, for example, placing the same in an oven or submerging in a water bath. After curing, the anode flow field plate and a cathode flow field plate may be adhesively bonded together (55) to form a bipolar flow field plate, and, optionally, followed by curing the adhesive (56).

In Route E in FIG. 5, the low viscosity coating resin is used as the adhesive to bond the anode flow field plate and the cathode flow field plate to form a bipolar flow field plate (57). The bipolar flow field plate is then subjected to an elevated temperature, such as in an oven or a hot water bath, to cure the polymeric impregnating resin, the low viscosity coating resin and the adhesive in one step (58).

### EXAMPLE

Sheets of TG504 expanded graphite, provided by Advanced Energy Technologies Inc. of Parma, Ohio, were embossed to a thickness of 0.9 millimeters with reactant flow fields on the first surfaces of the sheets (anode and cathode flow fields) to form anode and cathode flow field plates. The second surfaces of the anode and cathode flow field plates were also embossed with coolant flow fields. The embossed plates and a commercially available methacrylate resin, Hernon HPS991 (trademark), were degassed in separate vacuum chambers before submerging the plates into the methacrylate resin in a pressurized chamber for 100 minutes at 1 Torr. The plates were then washed and rinsed in water for 6 minutes, then cured in a hot water bath for 60 minutes at 96° C. to form substantially fluid impermeable flow field plates.

Another set of flow field plates were made the same way, except that after curing in the hot water bath, the second surface (i.e., coolant flow fields) of these plates were painted with a commercially available cyanoacrylate resin, Loctite 495 (trademark). The resin was then cured in an oven for approximately 15 minutes at 80° C. to form resin-reinforced flow field plates that were substantially fluid impermeable.

Bipolar flow field plates were made by adhesively attaching anode and cathode flow field plates around the peripheral edge of the plates and around each of the manifold openings such that the second surfaces of the plates faced and contacted each other. The standard bipolar flow field plates and the resin-reinforced bipolar flow field plates were then assembled with MEAs to form fuel cell stacks. The fuel cell stacks were compressed to approximately 70 PSI compression pressure and subjected to a temperature of 90° C. for 90 minutes to accelerate degradation. The fuel cell stacks were then cooled to room temperature and disassembled. It was found that the transition regions of the plates with no resin reinforcement had permanent compression set of approximately 100 microns, while the transition regions of the plates with resin-reinforcement had no permanent compression set.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

What is claimed is:

1. A method of making a planar flow field plate, the method comprising the steps of:
embossing a first flow field on a first surface of a sheet of electrically conductive material;
impregnating the sheet with a polymeric impregnating resin;
removing a portion of the resin from at least one of the first surface and an opposing second surface of the sheet to form at least one resin-depleted surface;
applying a coating of low viscosity coating resin to at least a portion of the at least one resin-depleted surface; and
curing the low viscosity coating resin,
and further comprising the step of curing the polymeric impregnating resin prior to or after the step of applying the coating of low viscosity coating resin.

2. The method of claim 1 wherein the step of curing the polymeric impregnating resin occurs prior to the step of applying the coating of low viscosity coating resin.

3. The method of claim 1 wherein the step of curing the polymeric impregnating resin occurs after the step of applying the coating of low viscosity coating resin.

4. The method of claim 1 wherein the sheet of electrically conductive material is expanded graphite.

5. The method of claim 1 wherein the polymeric impregnating resin is a phenolic, epoxy, acrylic, melamine, polyamide, polyamideimide, phenoxy resin, or mixture thereof.

6. The method of claim 1 wherein the polymeric impregnating resin is removed to a depth of 2 to 20 microns.

7. The method of claim 1 wherein the low viscosity coating resin partially impregnates at least a portion of the at least one resin-depleted surface.

8. The method of claim 1 wherein the viscosity of the low viscosity coating resin is less than 400 cp.

9. The method of claim 1 wherein the viscosity of the low viscosity coating resin is less than 100 cp.

10. The method of claim 1 wherein the low viscosity coating resin is an epoxy resin.

11. The method of claim 2 further comprising the step of embossing a second flow field on the opposing second surface of the sheet.

12. The method of claim 11 wherein the first flow field and the second flow field are embossed simultaneously on the first surface and the opposing second surfaces, respectively, of the sheet.

13. The method of claim 11 wherein the low viscosity coating resin is applied to at least a portion of at least one of a fuel transition region, an oxidant transition region, and a coolant transition region of the opposing second surface of the sheet.

14. The method of claim 11 further comprising the step of adhesively joining the opposing second surface to a companion flow field plate with an adhesive, and curing the adhesive to yield a bipolar flow field plate.

15. The method of claim 14 wherein the step of adhesively joining occurs subsequent to the step of curing the low viscosity coating resin and prior to curing the adhesive.

16. The method of claim 14 wherein the step of adhesively joining occurs subsequent to the step of applying the coating of low viscosity coating resin and prior to the step of curing the low viscosity coating resin.

17. The method of claim 16 wherein the step of curing the low viscosity coating resin and the step of curing the adhesive occurs simultaneously.

18. The method of claim 14 wherein the step of adhesively joining occurs subsequent to the step of curing the polymeric impregnating resin and prior to the step of applying the coating of low viscosity coating resin.

19. The method of claim 18 wherein the step of curing the low viscosity coating resin and the step of curing the adhesive occurs simultaneously.

20. The method of claim 3 further comprising the step of embossing a second flow field on the opposing second surface of the sheet.

21. The method of claim 20 wherein the first flow field and the second flow field are embossed simultaneously on the first surface and the opposing second surfaces, respectively, of the sheet.

22. The method of claim 20 wherein the low viscosity coating resin is applied to at least a portion of at least one of a fuel transition region, an oxidant transition region, and a coolant transition region of the opposing second surface of the sheet.

23. The method of claim 20 further comprising the step of adhesively joining the opposing second surface to a companion flow field plate with an adhesive, and curing the adhesive to yield a bipolar flow field plate.

24. The method of claim 23 wherein the step of adhesively joining occurs subsequent to the steps of curing the polymeric impregnating resin and curing the low viscosity coating resin, and prior to curing the adhesive.

25. The method of claim 23 wherein the step of adhesively joining occurs prior to the steps of curing the polymeric impregnating resin and curing the low viscosity coating resin and curing the adhesive.

26. The method of claim 25 wherein the polymeric impregnating resin, the low viscosity coating resin and the adhesive are cured simultaneously.

27. A bipolar flow field plate made according to the method of claim 14.

28. A bipolar flow field plate made according to the method of claim 20.

29. The bipolar flow field plate of claim 27 wherein the second flow field is a coolant flow field.

30. The bipolar flow field plate of claim 28 wherein the second flow field is a coolant flow field.

31. A flow field plate comprising:
an electrically conductive material impregnated with a cured polymeric impregnating resin;
a first surface partially depleted of the cured polymeric impregnating resin, the first surface having at least one reactant flow field; and
an opposing second surface partially depleted of the cured polymeric impregnating resin, the opposing second surface having a header region at least partially coated with a cured low viscosity coating resin forming a resin-reinforced surface thereon.

32. The flow field plate of claim 31 wherein the cured polymeric impregnating resin is depleted to a depth of 2 to 20 microns from at least a portion of the first surface and the opposing second surface.

33. The flow field plate of claim 31 wherein the opposing second surface comprises coolant flow fields.

34. The flow field plate of claim 33 wherein the coolant flow fields are at least partially coated with a cured low viscosity coating resin forming a resin-reinforced surface thereon.

35. The flow field plate of claim 31 further comprising at least one manifold opening and at least one manifold seal groove.

36. The flow field plate of claim 31 wherein a header region on the first surface of the flow field plate is at least partially coated with the low viscosity coating resin.

37. A bipolar flow field plate comprising a first flow field plate and a second flow field plate, wherein the first and second flow field plates each comprise a compressible, electrically conductive material impregnated with a cured polymeric impregnating resin, and each further comprising:
a first surface that is partially depleted of the cured polymeric impregnating resin and comprising at least one reactant flow field; and
an opposing second surface that is partially depleted of the cured polymeric impregnating resin and at least partially coated in a header region with a cured low viscosity coating resin to form a resin-reinforced surface thereon;
wherein the opposing second surfaces of each of the first and second flow field plates are adhesively joined.

38. The bipolar flow field plate of claim 37 wherein the cured polymeric impregnating resin is depleted from a depth of 2 to 20 microns from at least a portion of the first surface and the opposing second surface of the first and second flow field plates.

39. The bipolar flow field plate of claim 37 wherein at least one of the opposing second surfaces of the first and second flow field plates comprises a coolant flow field.

40. The bipolar flow field plate of claim 37 wherein a header region on the first surface of at least one of the first and second flow field plates is at least partially coated with the low viscosity coating resin.

41. The bipolar flow field plate of claim 37 wherein the first flow field plate and the second flow field plate are adhesively joined together around a peripheral edge thereof.

42. A fuel cell comprising a membrane electrode assembly disposed adjacent to at least one bipolar flow field plate of claim 37.
